(19) United States
(12) Patent Application Publication
(10) Pub. No.: US 2003/0147012 A1
(43) Pub. Date: Aug. 7, 2003

(54) Method for detecting scene changes in compressed video data

(76) Inventors: Kenny Hsiao, Keelung (TW); Min-Shu Chen, Taipei (TW)

Correspondence Address: BIRCH STEWART KOLASCH & BIRCH, PO BOX 747, FALLS CHURCH, VA, 22040-0747, US

(21) Appl. No.: 10/211,574

(22) Filed: Aug. 5, 2002

(30) Foreign Application Priority Data
Feb. 7, 2002 (TW) 91102260

(51) Int. Cl. H04N 7/12

(52) U.S. Cl. 348/700; 375/240.26

(57) ABSTRACT

A method for detecting scene changes in compressed video data. First, the timecodes recorded in the user data area of two adjacent video frames in the compressed video data are read. Then, it is determined whether the time interval between the timecodes is longer than a standard period. If the time interval between the timecodes is longer than the standard period, a scene change of the compressed video data is detected.

### BACKGROUND OF THE INVENTION

1. Field of the Invention

The present invention relates to a method for processing compressed digitized video data, and particularly to a method for detecting scene changes in compressed video data.

2. Description of the Related Art

In recent years, the popularization of optical recording devices such as DV camcorders has made common use of digitized video data, such as AVI files, feasible. The digitized video data can be edited easily, and conserved conveniently and securely. In uncompressed files, video data is stored frame by frame, and a timecode is tagged on each of the frames, which indicates the corresponding frame number and time information.

However, there are limitations in bandwidth and capacity so that video data must be compressed to reduce the size before transmission to computer or exchange on the Internet. When video data is compressed under current compression algorithms, such as MPEG algorithm, timecodes of the uncompressed video data are directly dropped.

Consequently, when there is a need to detect a scene change in compressed video data, it is most popular to compare the content of adjacent frames or pictures. To accomplish this object, a variety of implementations have been developed. An example of this is U.S. Pat. No. 5,774,593, in which a scene change is detected by analyzing P-pictures using average error power. Another example of this is U.S. Pat. No. 5,757,968, in which a scene change is detected by evaluating the quantity of the information of the input picture data. All of the above methods are content-based and time-consuming.

### SUMMARY OF THE INVENTION

It is therefore an object of the present invention to provide a method for detecting scene changes in compressed video data that records the timecode of the uncompressed video data into the unused user data area of the compressed video data and identifies video frames with interrupted timecodes as scene changes in the compressed video data.

To achieve the above object, a method for detecting scene changes in compressed video data according to one embodiment of the present invention is provided. First, the timecodes recorded in the user data area of two adjacent video frames in the compressed video data are read. Then, it is determined whether the time interval between the timecodes is longer than a standard period. If the time interval between the timecodes is longer than the standard period, a scene change of the compressed video data is detected.

Further, a method for compressing uncompressed data into compressed data, according to another embodiment of the present invention is also provided. First, the video frames of the uncompressed data are transformed into compressed video frames. Then, the compressed video frames are recorded into the compressed data according to a compression format. Finally, the timecodes corresponding to the video frames are recorded into the user data area of the corresponding compressed video frames in the compressed data according to the compression format.

In addition, a scene table recording all scenes and their corresponding video frames is recorded into the user data area of a predetermined video frame in the compressed video data.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a flowchart illustrating the operation of the method for compressing uncompressed data into compressed data according to the embodiment of the present invention;

FIG. 2 is a schematic diagram showing the transformation relation between the uncompressed data sequence and the compressed data sequence;

FIG. 3 is a schematic diagram showing a video sequence with MPEG format;

FIG. 4 shows an example of a scene table;

FIG. 5 illustrates the operation of the method for detecting scene changes in compressed video data according to the embodiment of the present invention; and

FIG. 6 illustrates the operation of another method for detecting scene changes in compressed video data according to the embodiment of the present invention.

### DETAILED DESCRIPTION OF THE INVENTION

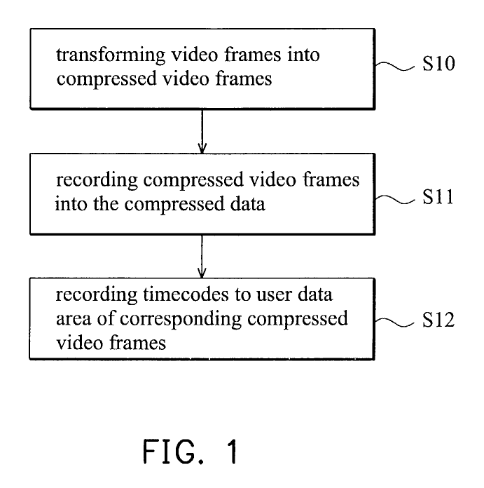

FIG. 1 shows the operation of the method for compressing uncompressed data into compressed data according to the embodiment of the present invention. The uncompressed data contains an uncompressed data sequence composed of uncompressed video frames, and the compressed data contains a compressed data sequence to record compressed video frames.

First, in step S10, the uncompressed video frames in the uncompressed data sequence of the uncompressed data are transformed into compressed video frames. Then, in step 11, the compressed video frames are recorded into the compressed data sequence of the compressed data according to a compression format, such as MPEG format. Finally, in step 12, the timecodes corresponding to the uncompressed video frames are recorded into the user data area of the corresponding compressed video frames in the compressed data sequence of the compressed data according to the compression format.

Note that the whole compression process is finished if all the uncompressed video frames in the uncompressed data sequence are transformed and all the timecodes corresponding to the uncompressed video frames are recorded into the compressed data.

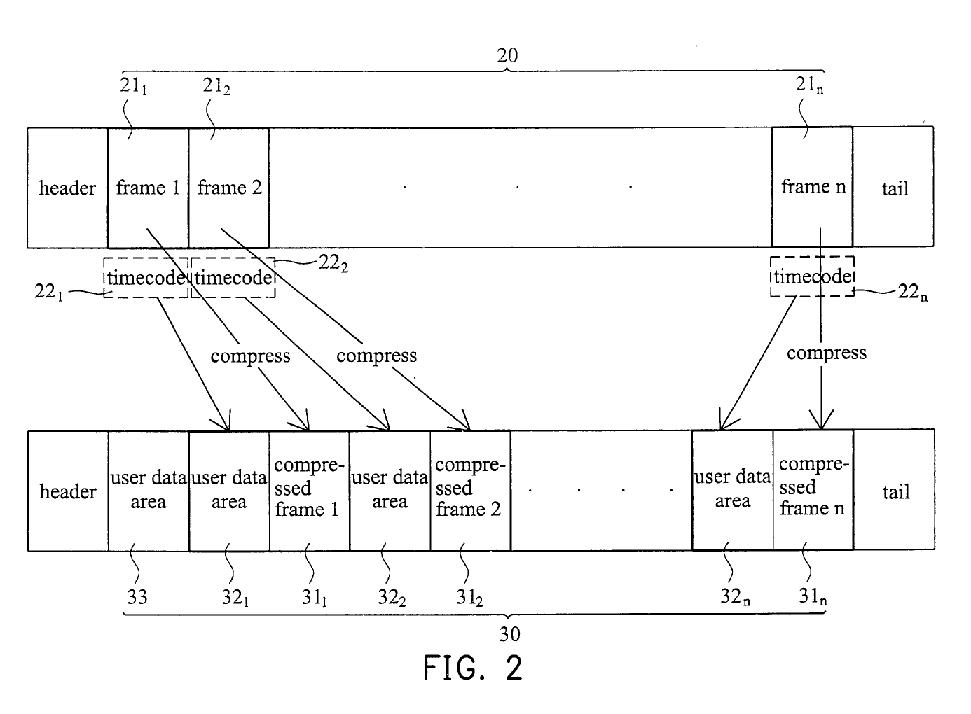

FIG. 2 shows the transformation relation between the uncompressed data sequence and the compressed data sequence as illustrated in FIG. 1. Each of the uncompressed video frames 21₁˜21ₙ in the uncompressed data sequence 20 is compressed and recorded into the position of each of the corresponding compressed video frames 31₁˜31₁ in the compressed data sequence 30, and each of the timecodes 22₁˜22ₙ corresponding to the uncompressed video frames 21₁˜21ₙ in the uncompressed data sequence 20 is recorded into each of the user data area 32₁˜32ₙ of the corresponding compressed video frames 31₁˜31ₙ in the compressed data sequence 30.

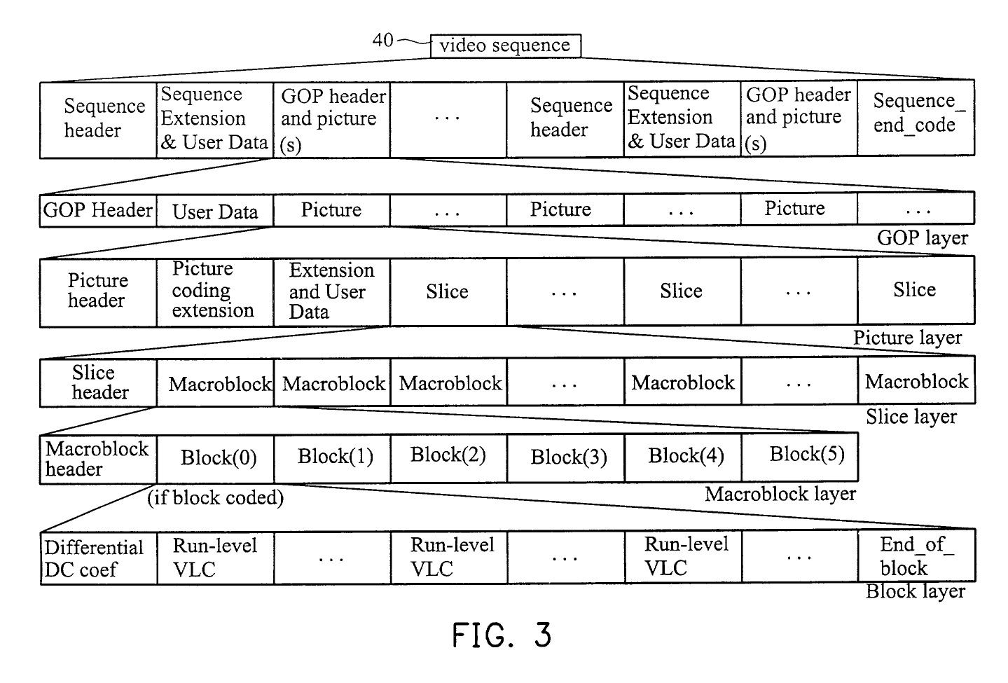

FIG. 3 shows a video sequence with MPEG format. A video sequence 40 always starts with a sequence header and a sequence user data (sequence extension & user data) followed by at least one or more groups of pictures (GOP) and ended with a sequence_end_code. Below the sequence layer in FIG. 3 is a group of pictures. A group of pictures always starts with a GOP header and a GOP user data followed by at least one picture. Each picture in the GOP layer in FIG. 3 has a picture header and a picture user data (picture extension & user data) followed by one or more slices. In turn, each slice in the picture layer is made up of a slice header and one or more groups of DCT blocks, called macroblocks. Each block in the macroblock layer is made up of a differential DC coefficient followed by at least one or more run-level VLC (variable length code) and ended with a end_of_block. Since each of the pictures (frames) in the GOP layer has a corresponding picture user data area, the method for compressing uncompressed data into compressed data according to the embodiment of the present invention can apply MPEG format to record the timecodes for each of the uncompressed video frames into the corresponding picture user data areas. The recorded timecodes can be used for scene change detection for the compressed video frames, which will be illustrated in more details.

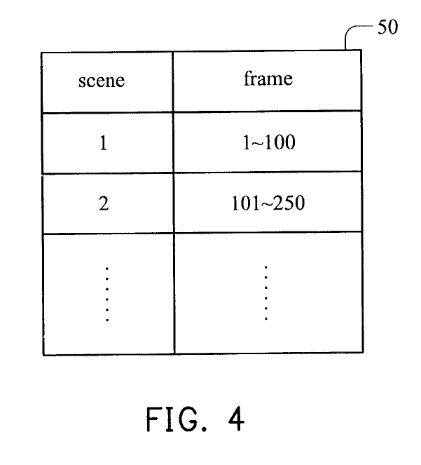

Further, a scene table recording all scenes and the corresponding compressed video frames can be recorded into the picture user data area of a predetermined compressed video frame, preferably the picture user data area of the last compressed video frame, or the GOP user data area, such as the user data area 33 in FIG. 2 in the compressed data sequence. FIG. 4 shows an example of a scene table 50. The scene table 50 has two fields, one field records scenes and the other records the frames corresponding to the scene. In this case, the scene table 50 records two scenes, the corresponding frames of the first scene are 1 to 100 and the corresponding frames of the second scene are 101 to 250.

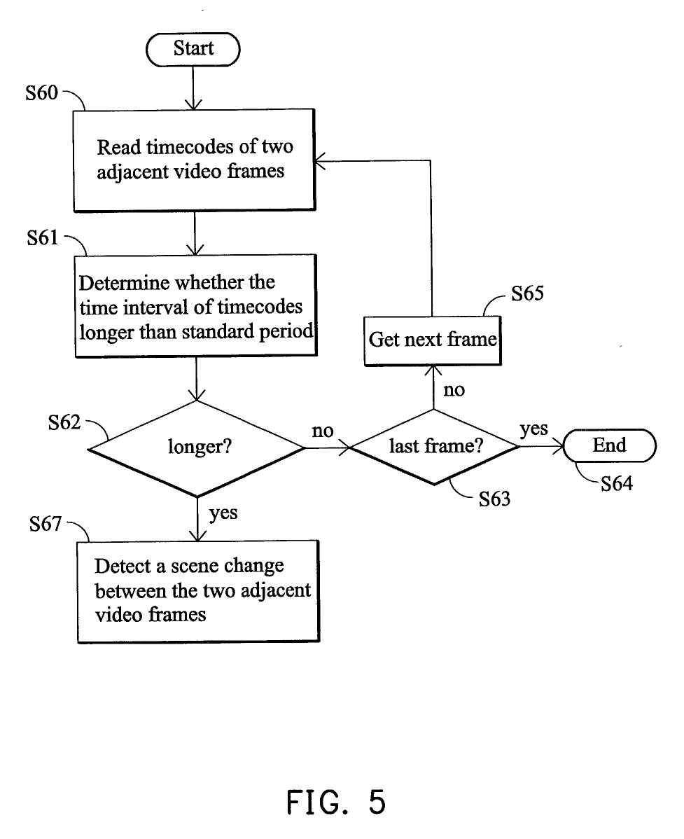

FIG. 5 shows the operation of the method for detecting scene changes in compressed video data according to the embodiment of the present invention.

As shown in FIG. 5, first, in step S60, the timecodes recorded in the user data area of two adjacent video frames in the compressed video data are read. Then, in step S61, it is determined whether the time interval between the timecodes is longer than a standard period. Note that the standard period can be preset by users or defined by the system.

If the time interval between the timecodes is not longer than the standard period (NO in step S62), the video frames are assessed to determine if any one of them is the last frame in the compressed video (S63). If any one of the video frames is the last frame, the process is finished (S64). If none of the video frames is the last frame, a pointer is pointed to the next frame in the compressed video data (S63) and the process returns to step S60.

If the time interval between the timecodes is longer than the standard period (YES in step S62), a scene change of the compressed video data is detected (S67).

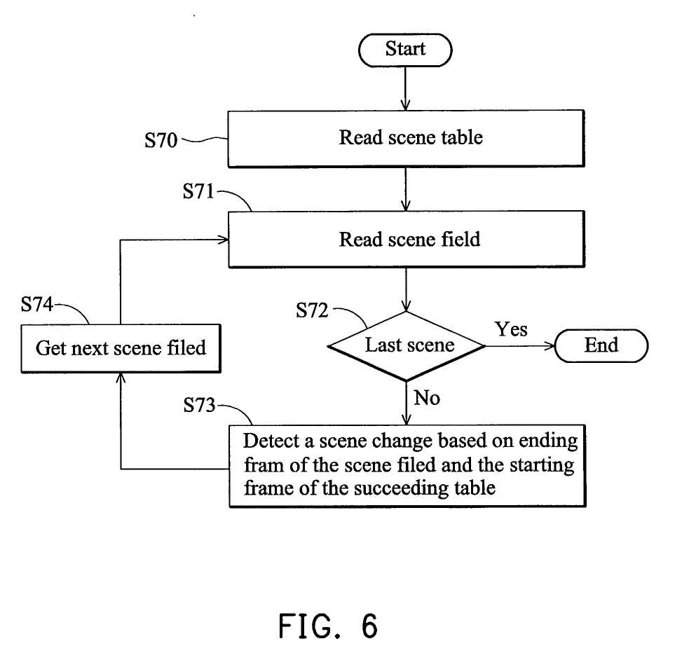

FIG. 6 illustrates the operation of another method for detecting scene changes in compressed video data according to the embodiment of the present invention

As shown in FIG. 6, first, in step S70, the scene table recorded in the picture user data area of a predetermined compressed video frame or the GOP user data area in the compressed data sequence is read. Then, in step S71, the scene field of the scene table is read and checked. If the read scene field does not correspond to the last scene of the compressed video data (NO in step S72), then, in step S73, a scene change is determined by the ending frame corresponding to the scene field and the starting frame corresponding to the succeeding scene field. As shown in FIG. 4, a first scene change takes place between the ending frame (frame 100) corresponding to scene filed 1 and the beginning frame (frame 101) corresponding to scene field 2, a second scene change takes place between the ending frame (frame 250) corresponding to scene field 2 and the beginning frame (frame 251) corresponding to scene field 3, and so on. Then, in step S74, a next scene field is read and the process continues at step S71. If the read scene field corresponds to the last scene of the compressed video data (YES in step S72), then the process is finished.

In Sum, the present invention records the timecodes of the uncompressed video data into unused user data area of the compressed video data, and identify video frames with interrupted timecodes as the scene changes in compressed video data.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A method for detecting a scene change in compressed video data, comprising the steps of:
reading a first timecode and a second timecode respectively corresponding to two adjacent video frames in the compressed video data;
determining whether the time interval between the first timecode and the second timecode is longer than a standard period; and
determining whether a scene change takes place between the two adjacent video frames.

2. The method as claimed in claim 1 wherein the first and second timecodes are respectively recorded in the user data area of the two adjacent video frames in the compressed video data.

3. The method as claimed in claim 1 wherein the compressed video data conforms to the MPEG standard.

4. A method for compressing uncompressed data into compressed data, comprising the steps of:
transforming a video frame of the uncompressed data into a compressed video frame;
recording the compressed video frame into the compressed data according to a compression format; and
recording the timecode corresponding to the video frame into the user data area of the corresponding compressed video frame in the compressed data according to the compression format.

5. The method as claimed in claim 4, further recording a scene table into the user data area of a predetermined video frame in the compressed video data.

6. The method as claimed in claim 4, further recording a scene table into the GOP (groups of pictures) user data area of the compressed video data.

7. The method as claimed in claim5 wherein the scene table records at least one scene and the compressed video frames corresponding to the scene in the compressed video data.

8. The method as claimed in claim 6 wherein the scene table records at least one scene and the compressed video frames corresponding to the scene in the compressed video data.

9. The method as claimed in claim4 wherein the compression format is MPEG.

10. A method for detecting a scene change in compressed video data, comprising the steps of:
reading a scene table recorded in the compressed video data;
determining whether a scene is recorded in the scene table; and
detecting a scene change based on the frames of the scene and its succeeding scene.

11. The method as claimed in claim 10 wherein the compressed video data conforms to the MPEG standard.

12. The method as claimed in claim 10, wherein the scene table is recorded in the user data area of a predetermined video frame of the compressed video data.

13. The method as claimed in claim 10, wherein the scene table is recorded in the GOP (groups of pictures) user data area of the compressed video data.
